(19) United States
(12) Patent Application Publication
(10) Pub. No.: US 2003/0127135 A1
(43) Pub. Date: Jul. 10, 2003

(54) Fluid diverter apparatus and method

(76) Inventors: Dale Lee Gremillion, Round Rock, TX (US); Glen Duane Jenkins, Austin, TX (US)

Correspondence Address: J. Nevin Shaffer, Jr., Building One, Suite 360, 1250 Capital of Texas Highway, S., Austin, TX, 78746, US

(21) Appl. No.: 10/041,222

(22) Filed: Jan. 7, 2002

(51) Int. Cl. F16K 23/00

(52) U.S. Cl. 137/312

(57) ABSTRACT

A fluid diverter apparatus and method includes, in a processing system utilizing multiple fluids, a containment enclosure. A first drain connects the processing system with the containment enclosure. A remotely manipulable diverter is connected to the first drain inside the containment enclosure. A second drain is connected to the diverter on one end and to a first recovery system outside of the containment enclosure on the other end. A third drain is connected to the diverter on one end and to a second recovery system outside of the containment enclosure on the other end.

### FIELD OF THE INVENTION

This invention relates to a fluid diverter apparatus and method. In particular, the invention relates to a fluid diverter apparatus and method in a system wherein a process tool utilizes multiple fluids and one or more of which fluids are worthy of recapture and reclamation.

### BACKGROUND OF THE INVENTION

The prior art includes a wide variety of diverter mechanisms. Nonetheless, in systems where process tools are utilized in the creation of commercial products and where these process tools utilize multiple fluids during processing, prior art systems are extraordinarily wasteful. By way of example and not by limitation, the chemical mechanical polishing process (CMP) is one of the largest water consumers in integrated circuit manufacturing. The average polishing tool in this system utilizes in excess of seven gallons of water twenty four hours a day, seven days a week. Of this time, the prior art polishers are only operational typically for 60 to 65 percent of the time. This 35 to 40 percent of downtime translates into huge amounts of wasted clean usable water.

By way of further example, and again not by limitation, wet process benches are process tools that are some of the predominant water users in integrated circuit manufacturing. This is due to the fact that wet process benches are found in numerous places in the manufacturing process. Most wet process benches have two to four sinks, each holding from 13 to 30 gallons of water depending on the tool type. These wet process benches may perform one to three cycle rinses after processing, dependent on the individual circuit “recipe”. These secondary rinses represent a large source of wasted fluid. In short, the virgin silicon and semiconductor industries require tremendous amounts of water even when the process tools are not running due to the need to keep the tools wet at all times. The average semiconductor plant, in fact, uses approximately 2000 gallons per minute of Ultra pure water. This results in a significant amount of clean usable water be sent to local municipal treatment plants.

In addition to these examples, many more instances exist in a wide variety of manufacturing processes where fluids, including not only water but many types of chemicals, are utilized where it is not only desirable, but economically critical that as much of these process fluids be recaptured and reused as possible.

Thus, there is in need the art for providing an apparatus and method for diverting process fluids such that fluids capable of reclaim and reuse are captured.

### SUMMARY OF THE INVENTION

Accordingly, in a processing system utilizing multiple fluids, the fluid diverter apparatus and method of the present invention includes a containment enclosure. A first drain from the processing system is connected to the containment enclosure. A remotely manipulable diverter is connected to the first drain inside the containment enclosure. A second drain is connected to the diverter on one end and to a first recovery system outside of the containment enclosure on another end. A third drain is connected to the diverter on one end and to a second recovery system outside of the containment enclosure on another end.

In a another aspect of the invention, a signal receiver-sender is connected to the diverter for receiving a first signal from the processing system and sending a second signal to the diverter for manipulation thereof. In further aspects of the invention an overflow line is connected to the first drain inside the containment enclosure and to the third drain inside the containment enclosure and a leak detector is located inside the containment enclosure. In one aspect of the invention, the leak detector is a float switch. In another aspect of the invention an overflow sensor is provided.

In further aspects of the invention, the first and second signals are selected from a group including electrical, mechanical and pneumatic signals. In another aspect of the invention, the first signal is generated by the processing system and in another aspect of the invention the first signal is generated by an auxiliary signal generator connected to the process system. In one aspect of the invention, a programmable timer is connected to the signal receiver-sender. In another aspect of this invention, the programmable timer receives the first signal and delays the sending of the second signal by a preprogrammed amount.

In a further aspect of the invention, the diverter is open to the second fluid recovery system as a default position until the second signal is received. In other aspects of the invention, the first recovery system is a fluid reclaim system and the second recovery system is a waste fluid system.

In a further preferred embodiment, in a process tool utilizing at least two fluids with a process tool drain connected to the process tool for draining the fluids, a fluid diverter apparatus includes a containment enclosure and a first drain connected to the process tool drain and to the containment enclosure. A two-way diverter valve is located inside the containment enclosure and is connected to the first drain. A second drain is connected to the two-way diverter valve and to a fluid reclaim system outside of the containment enclosure. A third drain is connected to the two-way diverter valve and to a waste fluid system outside of the containment enclosure. Finally, a solenoid is connected to the two-way diverter valve for receiving a first signal from the process tool and for sending a second signal to the two-way diverter valve for operation thereof. Other aspects of this invention are provided as well, as disclosed more fully hereafter.

In yet a further preferred embodiment, in a system in which a process tool utilizes more than one fluid and where a fluid drain is connected to the process tool for draining the fluids, a fluid diverting method is provided, the method including the steps of providing a containment enclosure and connecting a first drain to the process tool drain and to the containment enclosure. A diverter valve is provided inside the containment enclosure and is connected to the first drain. A second drain is connected to the diverter valve and to a fluid reclaim system outside the containment enclosure. A third drain is connected to the diverter valve and to a waste fluid system outside the containment enclosure. A solenoid is connected to the diverter valve, the solenoid conformed to receive a first signal from the system and to send a second signal to the diverter valve for operation thereof. At this point, the process tool is operated thereby generating fluid to be sent to the waste fluid system and also generating a first signal to the solenoid. The solenoid generates a second signal and sends the second signal to the diverter valve so that the diverter valve is operated to send the fluid to the waste fluid system. Next, the process tool is operated, thereby generating fluid to be sent to the fluid reclaim system and also generating a first signal to the solenoid. Finally, the solenoid generates a second signal and sends the second signal to the diverter valve so that the diverter valve is operated to send the fluid to the fluid reclaim system.

### DESCRIPTION OF THE DRAWINGS

Other objects, features, and advantages of the present invention will become more fully apparent from the following detailed description of the preferred embodiment, the appended claims and the accompanying drawings in which:

FIG. 1 is a plan view of the fluid diverter apparatus of the present invention;

FIG. 2 is a schematic diagram of the fluid diverter apparatus of the present invention;

FIG. 3 is a schematic diagram illustrating the flow of fluid to be reclaimed;

FIG. 4 is a schematic diagram illustrating the transition from fluid to be reclaimed to fluid to be sent to a waste system;

FIG. 5 is a schematic diagram illustrating the flow of fluid to the waste system; and

FIG. 6 is a schematic diagram illustrating the transition from fluid to be sent to the waste system to fluid to be sent to be reclaimed.

### DETAILED DESCRIPTION OF THE INVENTION

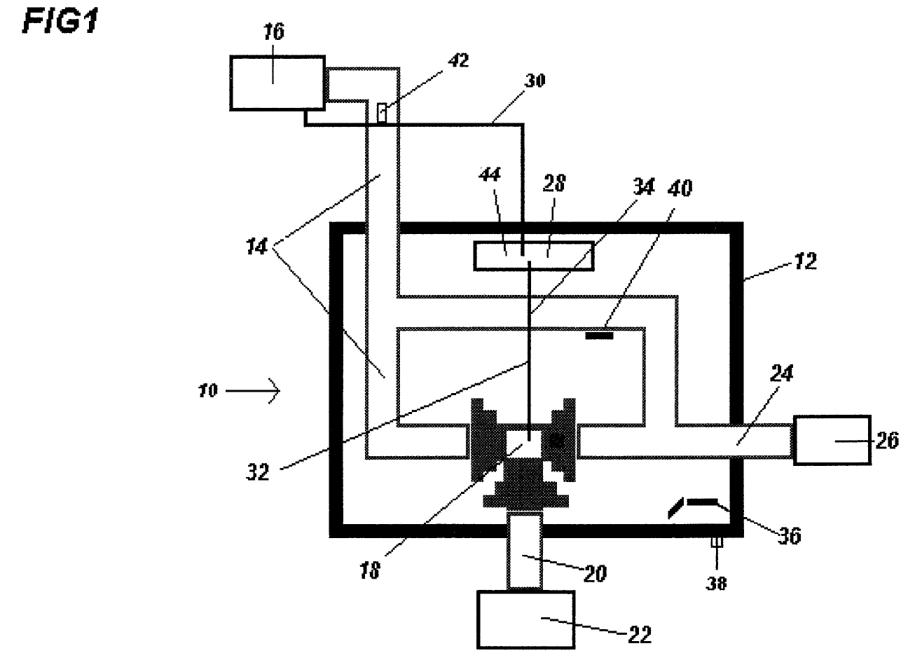

The preferred embodiment of the present invention is illustrated by way of example in FIGS. 1-6. With specific reference to FIG. 1, fluid diverter apparatus 10 of the present invention includes containment enclosure 12. A first drain 14 is connected to processing system 16 and to the containment enclosure 12. A remotely manipulable diverter 18 is connected to first drain 14 inside containment enclosure 12 as illustrated. A second drain 20 is connected to the diverter 18 inside the containment enclosure 12 on one end and to a first recovery system 22 outside of the containment enclosure 12 on another end. A third drain 24 is connected to diverter valve 18 inside the containment enclosure 12 on one end and to second recovery system 26 outside of containment enclosure 12 on another end.

A further aspect of the invention includes signal receiver-sender 28 connected by connection 30 to processing system 16. Signal receiver-sender 28 is conformed to receive a first signal from processing system 16 via connection 30 and to send a second signal to diverter 18 inside containment enclosure 12.

In a further aspect of the invention, overflow line 34 is connected to first drain 14 inside containment enclosure 12 and to third drain 24 inside containment enclosure 12. Also, leak detector 36 inside containment enclosure 12 alerts a user that a leak has occurred. On the occurrence of a leak, leak drain 38 is provided to safely drain a leak from within containment enclosure 12. In a preferred embodiment, leak detector 36 takes the form of a float switch.

In further aspects of the invention, an overflow sensor 40 is provided within containment enclosure 12. Should an overflow occur, overflow line 34 directs the overflow to second recovery system 26. In the meantime, overflow sensor 40, of a type commonly now known or hereafter developed, alerts a user that an overflow situation has occurred so that remedial steps may be taken.

The first signal, discussed above, generated by processing system 16, as will be discussed more fully hereafter, may be any type of signal now known or hereafter developed including wireless. In one aspect of the invention, the first signal is selected from a group including electrical, mechanical and pneumatic signals. Likewise, the second signal, discussed above, may be of any type now known or hereafter developed including wireless, and is selected from a group including, but not limited to, electrical, mechanical and pneumatic.

Further aspects of the invention include fluid diverter apparatus 10 wherein the first signal is generated by the processing system 16. In another aspect of the invention, the first signal is generated by an auxiliary signal generator 42 connected to processing system 16. For example, auxiliary signal generator 42 may be located within first drain 14 connected with processing system 16.

In a further aspect of the invention, a programmable timer 44 is connected to signal receiver-sender 28. In one aspect of the invention, programmable timer 44 receives the first signal from processing system 16 and delays the sending of the second signal to the diverter 18 by a preprogrammed amount, as will be discussed more fully hereafter.

In still further aspects of the invention, in a preferred embodiment, diverter 18 is open to the second fluid recovery system 26 as a “default” position until the second signal is received from the signal receiver-sender 28. In this aspect of the invention, second recovery system 26 is a waste fluid system and first recovery system 22 is a fluid reclaim system, as such systems are now known in the art or hereafter developed.

Still referring to FIG. 1, in a preferred embodiment of the invention, remotely manipulable diverter 18 is a two-way diverter valve and signal receiver-sender 28 is a solenoid as two-way diverter valves and solenoids are now known or hereafter developed.

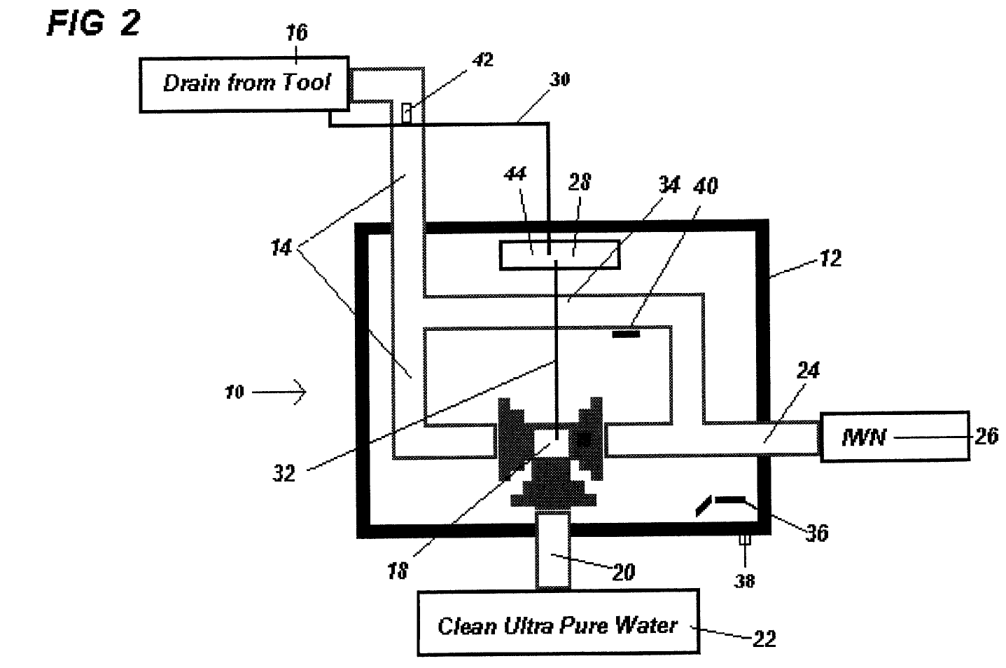

Referring now to FIG. 2, the general operation of fluid diverter apparatus 10 in a preferred embodiment will be described. In use, a 24 V DC constant signal is supplied to signal receiver-sender/solenoid 28 so as to hold diverter valve 18 in the “reclaim” position i.e. open to second drain 20 and thereby to first recovery system/fluid reclaim system 22 outside of containment enclosure 12. In a preferred embodiment, when the 24 V DC constant is removed, diverter valve 18 returns to its “default” position i.e. directing fluid through the third drain 24 to second recovery system/waste fluid system 26 outside of containment enclosure 12.

FIG. 2 also illustrates leak detector/float switch 36 located in the bottom of the inside of containment enclosure 12. In operation, leak detector/float switch 36 raises as it floats up and sends a signal of any convenient sort to a user to advise and alert the user that there is a leak within containment enclosure 12.

FIG. 2 also shows a preferred placement for overflow sensor 40. Overflow sensor 40 is provided such that if two-way diverter valve 18 fails, instead of fluid backing up to the processing system 16, overflow line 34 directs the overflow to the second recovery system/waste recovery system 26.

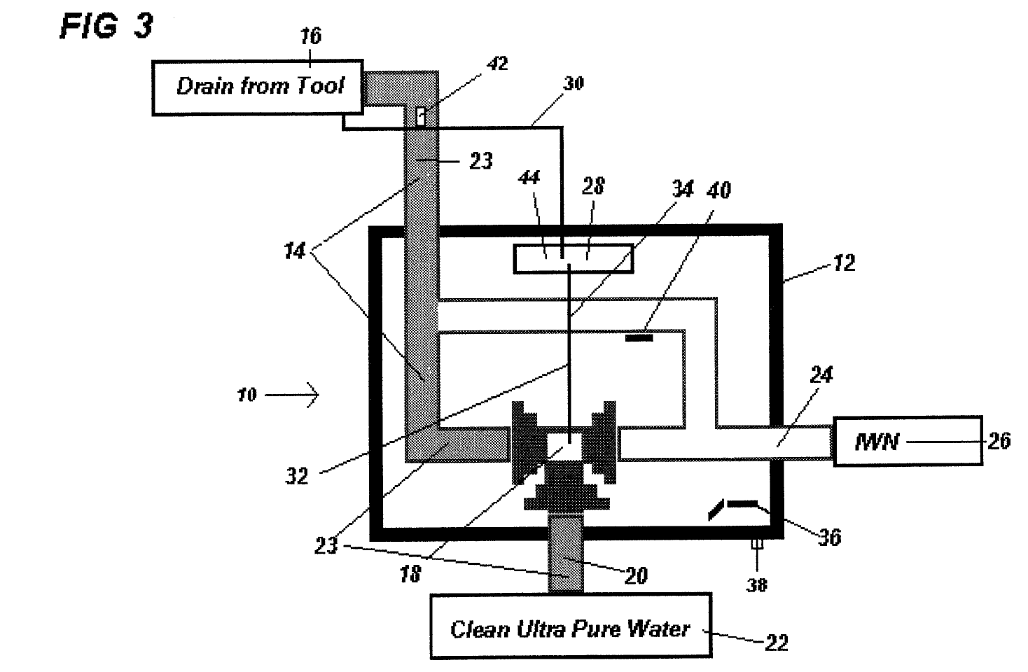

Referring now to FIGS. 3-6, the operation of fluid diverter apparatus 10 in a preferred embodiment is described. FIG. 3 illustrates the operation of fluid diverter apparatus 10 wherein the user has determined that the fluid 23 utilized in the processing system 16, by any number of process tools, as discussed above, now known or hereafter developed, is reclaimable. By way of example and not by limitation, the fluid 23 may be clean Ultra pure water used in the fabrication of integrated circuits. As illustrated, in a preferred embodiment, a 24 V DC constant signal is supplied to signal receiver-sender/solenoid 28 to hold diverter valve 18 in the reclaim position. As such, as illustrated in FIG. 3, clean process water 23 comes in from the processing system 16/process tool and is diverted through diverter valve 18 and second drain 20 to first recovery system/fluid reclaim system 22.

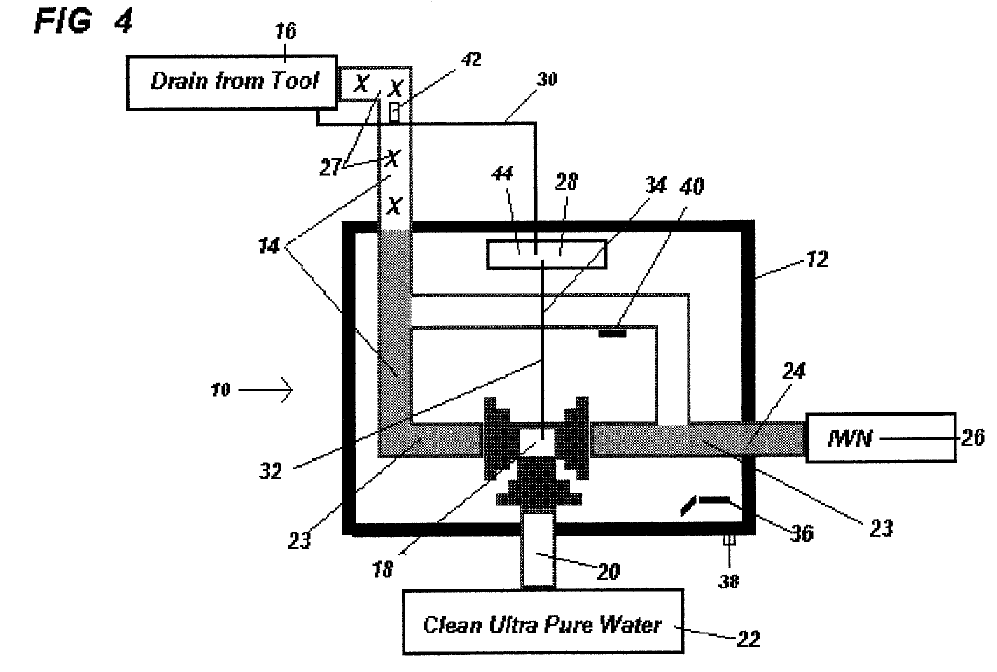

Referring now to FIG. 4, the schematic shows the operation of fluid diverter apparatus 10 when changing from a reclaim position to a waste retention position. In operation, a first signal, 24 V DC signal, is received when a chemical is introduced into drain line 14. The portion of drain line 14 holding chemical 27 is shown with “Xs”, in FIG. 4. The 24 V DC constant signal, discussed in reference to FIG. 3 earlier, is interrupted by the 24 V DC first signal from processing system/process tool 16. This first signal interrupts the 24 V DC constant signal, thereby, in effect, sending a second signal, a negative signal, by removing power from signal receiver-sender/solenoid 28 which returns diverter valve 18 to its default position to second recovery system/waste recovery system 26. As illustrated, the early first signal from processing system 16 results in the diversion of a small portion of clean water 23 being diverted to waste 26.

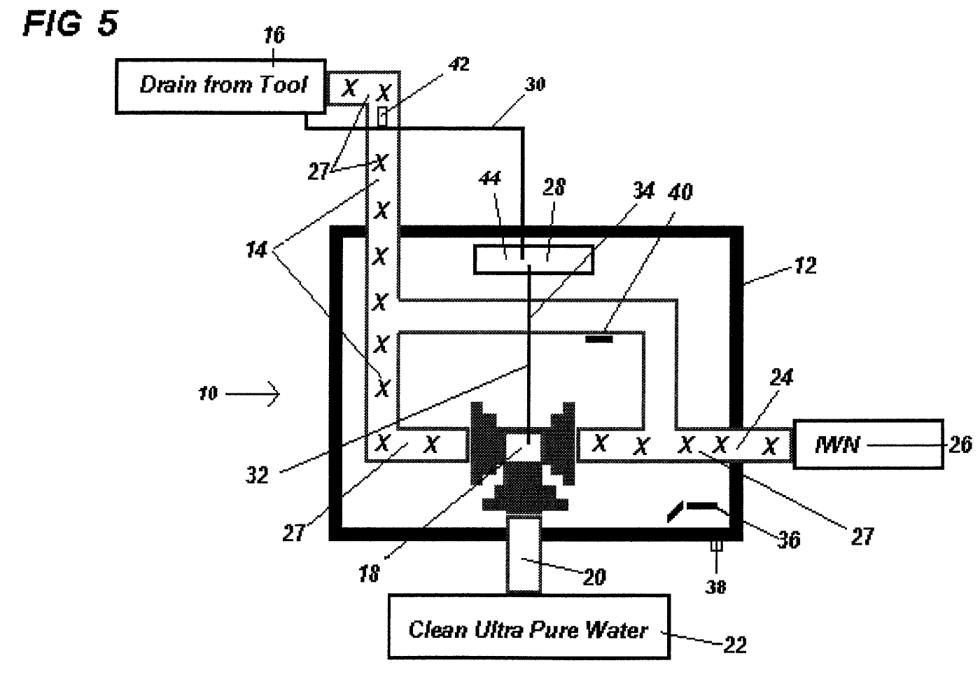

Referring now to FIG. 5, the schematic illustrates the state of the system wherein the 24 V DC constant first signal from the processing system 16 continuously interrupts the second signal, the 24 V DC constant signal from signal receiver-sender/28 used to keep diverter valve 18 open to the first recovery system/fluid reclaim system 22. To reiterate, the 24 V DC first signal from processing tool 16 in this instance removes power from the solenoid 28 thereby keeping diverter valve 18 in the waste recovery default position 26. As a result, chemical fluid 27 from processing system 16 is directed through first drain 14 to diverter valve 18 and through third drain 24 to second recovery system/reclaim system 26.

Any convenient signal system now known or hereafter developed may be utilized. In this regard, auxiliary signal generator 42, as previously mentioned, may be utilized to detect the change of fluids and generate a signal from fluids exiting processing system 16. Likewise, the first signal from processing system 16 may be captured from the process tool signals used in the operation of the process tool. That is, the signal to the process tool to “add chemical” can be captured directly from the processing system 16 or from the auxiliary signal generator 42. Also, it should be understood that while the operation of fluid diverter apparatus 10 is described herein with reference to two fluids, a chemical 27 and water 23, multiple fluids can be handled by the invention with up to four or more signals being generated by the processing system 16 as desired by the user and as is well within the ordinary skill levels in the art.

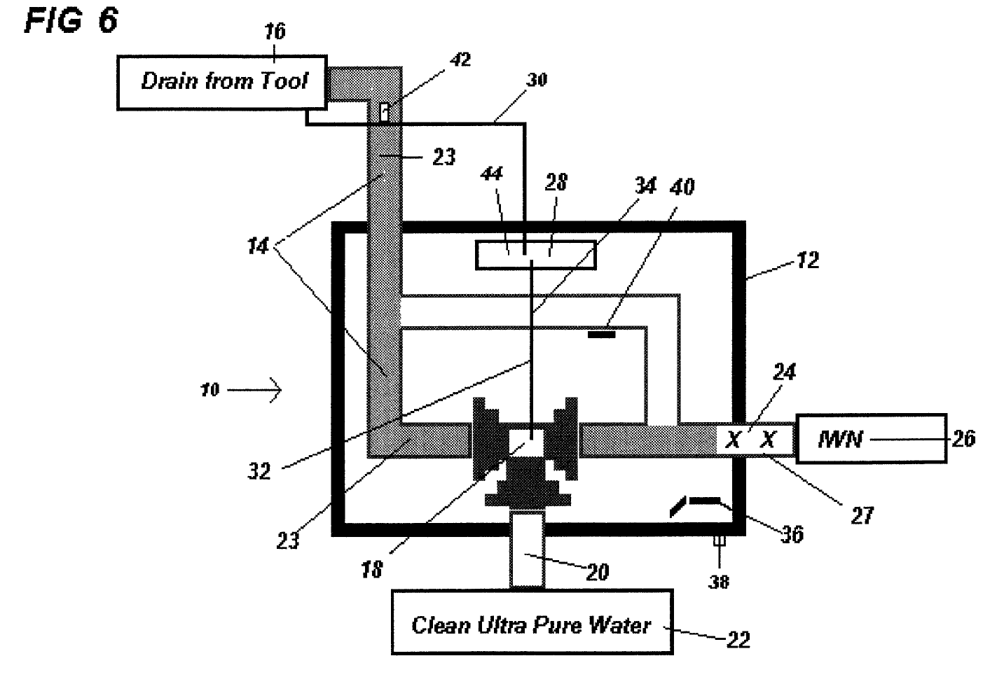

Referring now to FIG. 6, the transition of the fluid diverter apparatus 10 from a waste capture system to a fluid recovery and reclamation system is described. As illustrated, the first signal from the processing system 16 is removed when process water 23 begins to flow in first drain 14 as detected by auxiliary signal generator 42 or as received directly from the signal to the process tool. At that point, the 24 V DC constant is once again supplied by signal receiver-sender/solenoid 28. In a preferred embodiment, programmable timer 44 is utilized. When utilized, programmable timer 44 prevents the 24 V DC constant second signal from being immediately sent to receiver-sender/solenoid 28. Instead, a preprogrammed, predetermined delay is provided by programmable timer 44. The delay enables all of the chemical 27, marked by “Xs” in the figure, to be diverted through diverter valve 18 to second recovery system 26. The delay is programmed such that once the programmable timer 44 has timed out and the 24 V DC constant signal is returned to diverter valve 18 so as to return diverter valve 18 to the reclaim position shown in FIG. 3, all of the chemical 27 and a little of the water 23 has been sent through diverter valve 18 to second recovery system/waste recovery system 26. As a result, only clean Ultra pure water 23 is ever directed through diverter valve 18 and second drain 20 to first recovery system/reclaim system 22 and the system is once again in the condition illustrated in FIG. 3.

The description of the present embodiments of the invention have been presented for purposes of illustration but are not intended to be exhaustive or to limit the invention to the form disclosed. Many modifications and variations will be apparent to those of ordinary skill in the art. As such, while the present invention has been disclosed in connection with the preferred embodiment thereof, is should be understood that there may be other embodiments which fall within the spirit and scope of the invention as defined by the following claims.

1. In a processing system utilizing multiple fluids, a fluid diverter apparatus, the apparatus comprising:
a) a containment enclosure;
b) a first drain from said processing system connected to said containment enclosure;
c) a remotely manipulable diverter connected to said first drain inside said containment enclosure;
d) a second drain connected to said diverter on one end and to a first recovery system outside of said containment enclosure on another end; and
e) a third drain connected to said diverter on one end and to a second recovery system outside of said containment enclosure on another end.

2. The apparatus of claim 1 further comprising a signal receiver-sender connected to said diverter for receiving a first signal from said processing system and sending a second signal to said diverter for manipulation thereof.

3. The apparatus of claim 1 further comprising an overflow line connected to said first drain inside said containment enclosure and to said third drain inside said containment enclosure.

4. The apparatus of claim 1 further comprising a leak detector inside said containment enclosure.

5. The apparatus of claim 4 wherein said leak detector is a float switch.

6. The apparatus of claim 3 further comprising an overflow sensor.

7. The apparatus of claim 2 wherein said first signal is selected from a group including electrical, mechanical and pneumatic signals.

8. The apparatus of claim 2 wherein said second signal is selected from a group including electrical, mechanical and pneumatic signals.

9. The apparatus of claim 2 wherein said first signal is generated by the processing system.

10. The apparatus of claim 2 wherein the first signal is generated by an auxiliary signal generator connected to said processing system.

11. The apparatus of claim 2 further comprising a programmable timer connected to said signal receiver-sender.

12. The apparatus of claim 2 wherein said diverter is open to said second fluid recovery system as a default position until said second signal is received.

13. The apparatus of claim 11 wherein said programmable timer receives said first signal and delays the sending of said second signal by a pre-programmed amount.

14. The apparatus of claim 1 wherein said first recovery system is a fluid reclaim system.

15. The apparatus of claim 1 wherein said second recovery system is a waste fluid system.

16. In a process tool utilizing at least two fluids with a process tool drain connected to the process tool for draining the fluids, a fluid diverter apparatus, the apparatus comprising:
a) a containment enclosure;
b) a first drain connected to the process tool drain and connected to the containment enclosure;
c) a two way diverter valve inside the containment enclosure connected to the first drain;
d) a second drain connected to the two way diverter valve and to a fluid reclaim system outside of the containment enclosure;
e) a third drain connected to the two way diverter valve and to a waste fluid system outside of the containment enclosure; and
f) a solenoid connected to the two way diverter valve for receiving a first signal from the process tool and for sending a second signal to the two way diverter valve for operation thereof.

17. The apparatus of claim 16 further comprising an overflow line connected to the first drain and to the third drain inside the containment enclosure.

18. The apparatus of claim 16 further comprising a leak detector inside the containment enclosure.

19. The apparatus of claim 16 wherein the first signal is generated by the process tool.

20. The apparatus of claim 16 wherein the first signal is generated by an auxiliary signal generator connected to the process tool.

21. The apparatus of claim 16 further comprising a programmable timer connected to the solenoid.

22. The apparatus of claim 16 wherein the two way diverter valve is open to the waste fluid drain as a default position until the second signal is received.

23. In a system in which a process tool utilizes more than one fluid and where a fluid drain is connected to the process tool for draining the fluids, a fluid diverting method, the method including the steps of:
a) providing a containment enclosure;
b) connecting a first drain to the process tool drain and to the containment enclosure;
c) providing a diverter valve inside the containment enclosure and connecting the diverter valve to the first drain;
d) connecting a second drain to the diverter valve and to a fluid reclaim system outside the containment enclosure;
e) connecting a third drain to the diverter valve and to a waste fluid system outside the containment enclosure;
f) connecting a solenoid to the diverter valve, the solenoid conformed to receive a first signal from the system and to send a second signal to the diverter valve for operation thereof;
g) operating the process tool, thereby generating fluid to be sent to the waste fluid system and also generating a first signal to the solenoid;
h) the solenoid generating a second signal and sending the second signal to the diverter valve so that the diverter valve is operated to send the fluid to the waste fluid system;
i) operating the process tool, thereby generating fluid to be sent to the fluid reclaim system and also generating a first signal to the solenoid; and
j) the solenoid generating a second signal and sending the second signal to the diverter valve so that the diverter valve is operated to send the fluid to the fluid reclaim system.
